(19) United States
(12) Patent Application Publication
(10) Pub. No.: US 2023/0134999 A1
(43) Pub. Date: May 4, 2023

(54) NETWORK-BASED CALCULATION OF AFFINITY SCORE FROM TRANSACTION DATA

(71) Applicant: Visa Europe Limited, London (GB)

(72) Inventors: Hyeonmin NA, London (GB); Paul ROLLINGS, London (GB)

(73) Assignee: Visa Europe Limited, London (GB)

(21) Appl. No.: 17/915,420

(22) PCT Filed: Jun. 18, 2020
(86) PCT No.: PCT/IB2020/055721

§ 371 Date: Sep. 28, 2022

(51) Int. Cl. G06Q 30/0201; G06F 17/16

(52) U.S. Cl. CPC G06Q 30/0201; G06F 17/16

(57) ABSTRACT

Disclosed herein is a computer-implemented method for calculating an affinity score for an entity in one or more transactions of a plurality of transactions, each transaction involving the transfer of an asset from an associated sending entity to an associated receiving entity. The method comprises receiving data identifying a seed receiving entity, querying transaction data for the plurality of transactions to identify a set of sending entities based on each sending entity in the set of sending entities having been the sending entity in at least one transaction with the seed receiving entity, querying the transaction data to identify transactions having a ending entity in the set of sending entities, and determining a set of receiving entities based on the transactions having the sending entity in the set of sending entities. In this way, a set of sending entities and a set of receiving entities and associated transactions are identified. The method then proceeds by assigning the set of sending entities and the set of receiving entities as nodes in a network and transactions as links in the network, wherein a link corresponding to a transaction connects the sending entity for the transaction with the receiving entity for the transaction. An eigenvector centrality value calculation can then be performed for a node corresponding to a subject receiving entity of the set of receiving entities, and an affinity score determined for the subject receiving entity using the eigenvector centrality value, whereby the affinity score provides a measure of affinity between the subject receiving entity and the seed receiving entity.

### BACKGROUND

### Field

The present application relates to determining an affinity score, for example a measure of environmental impact, of an entity to a transaction and to computing apparatus for carrying out such a method.

### Description of the Related Technology

Green consumerism is a growing trend in which consumers take into account the effect on the environment of their purchases. However, without carrying out personal research, many green consumers have inadequate information regarding the environmental impact of their purchasing decisions. For example, while data may be available as to the carbon emission costs for different classes of merchants, e.g. for supermarkets and for airlines, it is much more difficult to find information regarding the differences between the carbon emission costs of different merchants within the same class.

While green consumers have a shared affinity for environmental sustainability, other groups of consumers may share different affinity, for example an affinity to a particular cause. It would be advantageous to provide a technique for providing an affinity score to a consumer based on the purchasing decisions of that consumer, but this presents a technical challenge simply on account of the vast amounts of transaction data generated in relation to electronic transactions.

### SUMMARY

According to a first aspect of the present disclosure, there is provided a computer-implemented method for calculating an affinity score for an entity in one or more transactions of a plurality of transactions, each transaction involving the transfer of an asset from an associated sending entity to an associated receiving entity. The method comprises receiving data identifying a seed receiving entity, querying transaction data for the plurality of transactions to identify a set of sending entities based on each sending entity in the set of sending entities having been the sending entity in at least one transaction with the seed receiving entity, querying the transaction data to identify transactions having a sending entity in the set of sending entities, and determining a set of receiving entities based on the transactions having the sending entity in the set of sending entities. In this way, a set of sending entities and a set of receiving entities and associated transactions are identified. The method then proceeds by assigning the set of sending entities and the set of receiving entities as nodes in a network and transactions as links in the network, wherein a link corresponding to a transaction connects the sending entity for the transaction with the receiving entity for the transaction. An eigenvector centrality value calculation can then be performed for a node corresponding to a subject receiving entity of the set of receiving entities, and an affinity score determined for the subject receiving entity using the eigenvector centrality value, whereby the affinity score provides a measure of affinity between the subject receiving entity and the seed receiving entity.

Where the affinity is to environmental concerns, the seed receiving entity may, for example, be an environmental charity. People transacting with environmental charities can be expected to have a high awareness of environmental issues, and to be guided in their purchasing decisions by that awareness. Accordingly, the merchants at which they make purchases are likely to have good environmental credentials. It is worth noting that transactions with an environmental charity are often one-way only, e.g. in the form of donation, and no goods or services are received in return for the transfer of money. Such donations indicate that the donors have a keen understanding and interest in environmental concerns. The method outlined above therefore provides a technique by which these environmental credentials can be quantified as measures of affinity through analysis of transaction data. These measures of affinity can then be used, for example, to inform a cohort of consumers with less in-depth awareness of environmental issues but who still wish to support environmental sustainability.

By establishing a network with nodes corresponding to transacting entities and links corresponding to transactions, known eigenvector centrality calculations such as the PageRank calculation or novel eigenvector centrality calculations can be performed. In this way, a vast amount of available transaction data can be processed to determine an affinity with an efficient use of computational resources.

According to a second aspect of the present disclosure, there is provided a server computer comprising a processor and computer readable medium storing executable instructions. The processor is configured to execute the executable instructions to receive data identifying a seed receiving entity, query a transaction database storing transaction records for a plurality of transactions, each transaction involving the transfer of an asset from an associated sending entity to an associated receiving entity, to identify a set of sending entities based on each sending entity in the set of sending entities having been the sending entity in at least one transaction with the seed receiving entity, query the transaction database to identify transactions having a sending entity in the set of sending entities, and determine a set of receiving entities based on the transactions having the sending entity in the set of sending entities. The server computer then assigns the set of sending entities and the set of receiving entities as nodes in a network and transactions as links in the network, wherein a link corresponding to a transaction connects the sending entity for the transaction with the receiving entity for the transaction. The server computer can then calculate an eigenvector centrality value for a node corresponding to a subject receiving entity of the set of receiving entities, and determine an affinity score for the subject receiving entity using the eigenvector centrality value, whereby the affinity score provides a measure of affinity between the subject receiving entity and the seed receiving entity.

According to a third aspect of the present disclosure, there is provided a computer readable medium storing executable instructions for execution by a processor. The executable instructions configure the processor to receive data identifying a seed receiving entity and query a transaction database storing transaction data for a plurality of transactions, each transaction involving the transfer of an asset from an associated sending entity to an associated receiving entity, to identify a set of sending entities based on each sending entity in the set of sending entities having been the sending entity in at least one transaction with the seed receiving entity. The processor is then configured to query the transaction database to identify transactions having a sending entity in the set of sending entities, and determine a set of receiving entities based on the transactions having the sending entity in the set of sending entities. The processor is then configured to assign the set of sending entities and the set of receiving entities as nodes in a network and transactions as links in the network, wherein a link corresponding to a transaction connects the sending entity for the transaction with the receiving entity for the transaction. The processor is subsequently configured to calculate an eigenvector centrality value for a node corresponding to a subject receiving entity of the set of receiving entities, and determine an affinity score for the subject receiving entity using the eigenvector centrality value, whereby the affinity score provides a measure of affinity between the subject receiving entity and the seed receiving entity.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 schematically shows a network of transacting entities and transactions developed from a seed transacting entity;

FIG. 2 is a block diagram schematically showing components of a transaction system of the present disclosure;

FIG. 3 schematically shows fields of transaction records stored by a transaction database of the transaction system of FIG. 2;

FIG. 4 schematically shows fields of entries in a merchant affinity score table of the transaction system of FIG. 2;

FIG. 5 is a flow chart schematically showing operations performed in the transaction system of FIG. 2 to calculate an affinity score for a merchant; and

FIG. 6 is a flow chart schematically showing operations performed in the transaction system of FIG. 2 to calculate an affinity score for a consumer.

### DETAILED DESCRIPTION OF CERTAIN INVENTIVE EMBODIMENTS

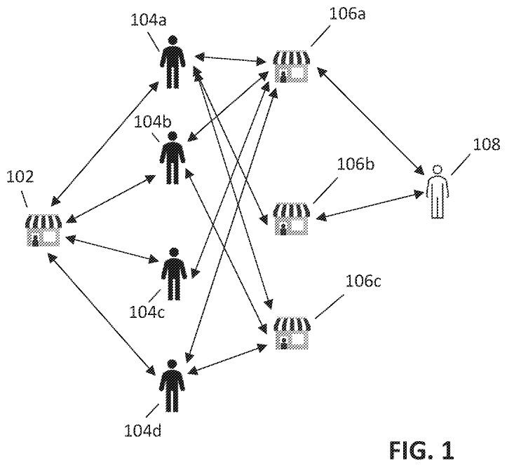

FIG. 1 schematically shows a network of transacting entities developed on the basis of transactions in which a seed receiving entity 102 is the receiving transacting entity. In this regard, it will be appreciated that each transaction involves a transfer from a sending entity to a receiving entity. With careful choice of the seed receiving entity 102, there may be a high expectation that sending transacting entities 104a-104d, hereafter collectively referred to as a set of sending entities 104, transacting with the seed receiving entity 102 will share an affinity with the seed receiving entity. In an example, the seed receiving entity 102 is an environmental charity, in which case the set of sending entities 104 can be expected to share an affinity for environmental sustainability with the environmental charity.

The set of sending entities 104 may in turn be party to transactions to other receiving entities 106a-106c, hereafter collectively referred to as the set of receiving entities 106. Given the affinity the set of sending entities 104 shares with the seed receiving entity 102, the set of sending entities 104 may be expected to choose to transact with parties sharing that affinity and therefore it may be expected that at least some of the set of receiving entities 106 will share an affinity with the seed receiving entity 102. For the example in which the seed receiving entity 102 is an environmental charity, it can be expected that the set of sending entities will preferentially transact with retailers having environmentally sustainable policies, such as supermarkets that have a policy to use no plastic packaging or to require a shopper to bring containers for packing their shopping to the supermarket, and to sell products from sources accredited to be environmentally sustainable.

It will be appreciated that not every transaction made by the set of sending entities 104 will necessarily be with a merchant having green affinity. Accordingly, the set of receiving entities 106 may have differing levels of affinity with the seed receiving entity 102. In order to quantify these differing levels of affinity. the set of sending entities 104 and the set of receiving entities 106 can be assigned as nodes in a network, with transactions between the set of sending entities 104 and the set of receiving entities 106 being assigned as links between the nodes. In this way, an eigenvector centrality calculation can be performed for each node corresponding to one of the set of receiving entities 106 to calculate an eigenvector centrality value, which in turn can be used to determine an affinity score for each node. For the example in which the seed receiving entity 102 is an environmental charity, the affinity value for a node could be used to determine a weighting factor to reduce an estimated carbon dioxide emission amount per unit transaction amount for the merchant category, identified e.g. by the merchant category code defined in ISO 18245, for the merchant corresponding to the node to take account of the expected environmentally sustainable policies for the merchant corresponding to the node.

An eigenvector centrality calculation provides a measure of the influence of a node in a network based on the concept that nodes with a higher number of connecting links have more influence than nodes with a lower number of connecting links. For the schematic example illustrated in FIG. 1, all four illustrated sending entities in the set of sending entities have links to a first one 106a of the set of receiving entities, while only one of the four illustrated sending entities in the set of sending entities 104 has a link to a second one 106b of the set of receiving entities and three of the four illustrated sending entities in the set of sending entities 104 have links to a third one 106c of the set of receiving entities 106. Accordingly, an eigenvector centrality calculation for each node corresponding to one of the set of receiving entities based on the number of connecting links will result in the first one 106a of the set of receiving entities 106 having the highest affinity score, followed by the third one 106c of the set of receiving entities 106 and the second one 106b of the set of receiving entities 106 will have the lowest score. Alternative eigenvector centrality calculations may also weight each connecting link by its corresponding transaction amount, in which case the determined affinity scores may be different.

In examples, the eigenvector centrality calculation could be based on the PageRank algorithm or the Katz centrality.

The affinity score for a receiving transacting entity has various uses. In itself, the affinity score provides a metric by which a receiving transacting entity can be assessed either individually over a period of time or in comparison with other receiving transacting entities at one instant in time. For the example in which the seed receiving entity 102 is an environmental charity, the affinity value could be used to compare merchants in the same commercial sector (e.g. to compare the perceived green credentials of different supermarkets by consumers), or to compare the perceived green credentials of an individual merchant (e.g. a supermarket) over time.

Alternatively, the affinity score could be used by sending transacting entities in the calculation of an affinity score for that sending transacting entity. For the schematic example illustrated in FIG. 1, a subject sending transacting entity 108, not in the set of sending entities 104, may carry out transactions at various receiving transacting entities, including the first receiving transacting entity 106a and the second receiving transacting entity 106b of the set of receiving entities 106. Using the transaction amounts of the transactions and the affinity scores of the first receiving transacting entity 106a and the second receiving transacting entity 106b, an affinity score can be calculated for the subject sending transacting entity 108. For the example in which the seed receiving entity 102 is an environmental charity, the set of receiving entities 106 are merchants and the affinity value for a merchant can be used to identify merchants preferred by consumers with strong environmental awareness. In this way, the affinity score allows the carbon footprint per monetary unit for the merchant to be adjusted to a lower level than for comparable merchants having the identical merchant category code (MCC) as defined in ISO 18245. The subject sending transacting entity 108 may be a consumer and the affinity value for that consumer may correspond to an estimated carbon dioxide emission associated with the spending of that user and segment the consumer to among the groups of consumers with different affinity to environmentally-friendly consumption. The consumer can then see how changes in their spending affects the associated estimated carbon dioxide emissions and also how they compare to benchmarks based on, e.g., country, region and the like.

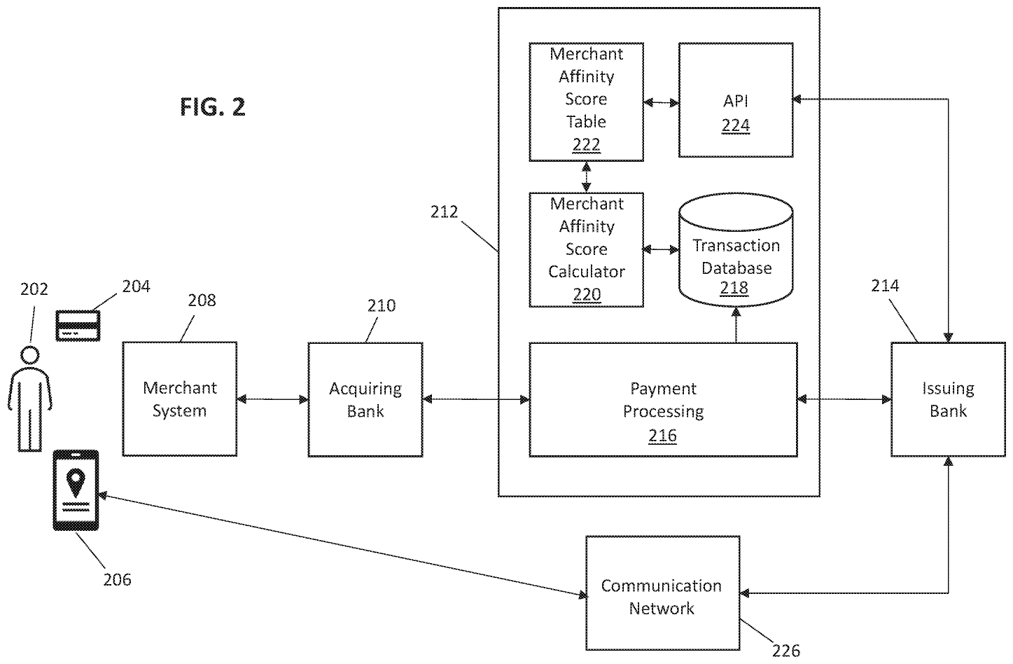

FIG. 2 illustratively shows a payment transaction system to which embodiments described herein have particular application.

A user 202 uses a financial instrument, such as a payment card 204 or a payment application on a mobile communications device 206, to perform a payment transaction with a merchant system 208. The user 202 may be on premises associated with the merchant, with the interaction occurring directly between the financial instrument and a point of sale (POS) terminal at the merchant, or the transaction may be an online transaction with the interaction with the merchant system be via a website or a merchant application on the mobile communication device 206.

The merchant system 208 passes transaction data for the transaction to an acquiring bank 210, which holds a financial account for the merchant. This transaction data includes a payment instrument identifier for the financial instrument, for example a Primary Account Number (PAN), a merchant identifier for the merchant and a transaction amount. Based on the payment instrument identifier, the acquiring bank will forward the transaction data for the transaction to a payment service provider network 212 for transmission to an issuing bank 214 that issued the financial instrument to the user 202.

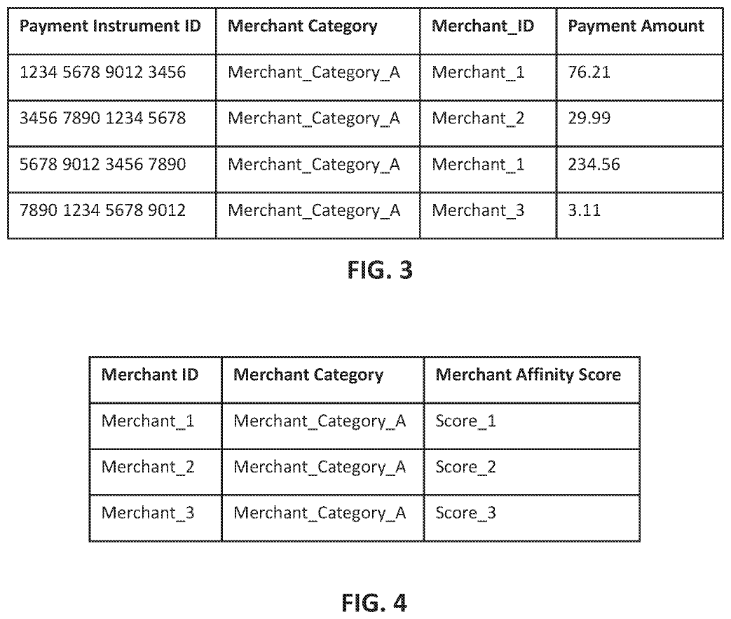

The payment service provider network 212 includes a payment processing system 216 which processes the transaction data for payment purposes. For example, the payment processing system 216 forwards messages between the acquiring bank 210 and the issuing bank 214, and also stores the transaction data as a record in a transaction database 218 of the payment service provider network 212. FIG. 3 schematically shows some of the transaction data stored in a record of a transaction in the transaction database 218. As shown, the stored data for the transaction includes the payment instrument identifier for the financial instrument, the merchant identifier, merchant category code (MCC:ISO18245) and the transaction amount. It will be appreciated that the transaction database will also store additional data in a record of a transaction, such as the authentication procedure performed, that is not shown in FIG. 3.

Returning to FIG. 2, the payment service provider network 212 will also include a merchant affinity score calculator 220, which calculates a merchant affinity score of each merchant within the respective merchant categories using transaction data from the transaction database 218, and stores the merchant affinity score for the merchant in an entry in a merchant affinity score table 222. As shown in FIG. 4, each entry in the merchant affinity score table 222 includes a merchant identifier, merchant category code and a corresponding merchant affinity score.

In this example, the merchant affinity score calculator is a server computer comprising a processor and a computer readable medium storing executable instructions that are executed by the processor to perform processing operations to calculate the merchant affinity score for a merchant.

The payment service provider network 212 also includes an Application Programming Interface (API) 224 via which remote systems can access data from the merchant affinity score table 224. In the example of FIG. 2, the issuing bank 214 is able to access, via the API 224, data in the merchant affinity score table. Accordingly, the issuing bank can calculate an affinity score for the user 202 by processing transaction data for the user 202, retrieving merchant affinity scores for the merchants identified in that transaction data, and calculating the affinity score for the user 202. As shown in FIG. 2, the issuing bank may forward the calculated affinity score for the user 202 to an application on the mobile communication device 206 of the user 202 via a communication network 225, such as a public land mobile network (PLMN). Alternatively, the issuing bank may make the affinity score for the user 202 available to the user 202 via a website.

While in the example of FIG. 2 the issuing bank calculates the affinity score for the user, it will be appreciated that the payment service provider network 212 could be modified to calculate the affinity score for the user 202. Alternatively, a third party system (not shown) could access transaction data for the user 202 from the issuing bank 214, merchant affinity scores from the payment service provider network 212 via the API 224, and calculate an affinity score for the user 202. The third party system may then make the affinity score for the user 202 available to the user 202 via an application on the mobile communication device 206 associated with the third party system or via a website.

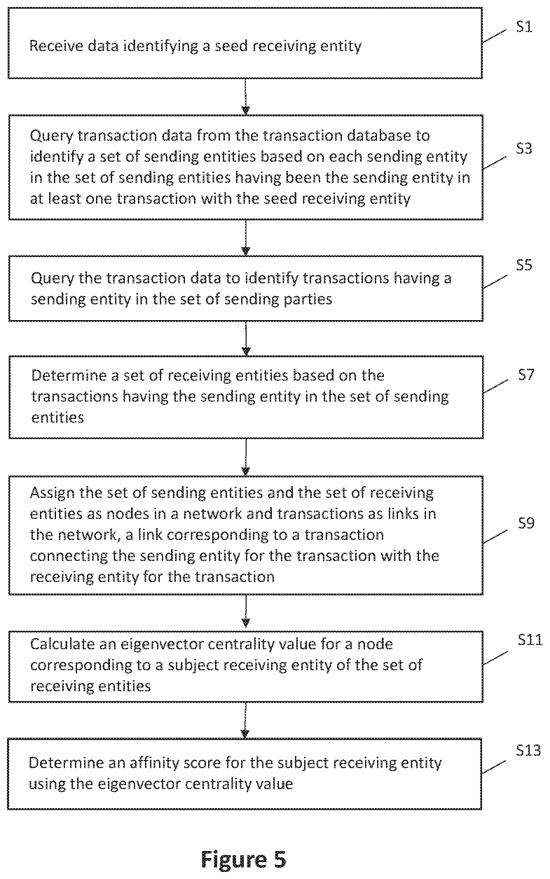

FIG. 5 is a flow chart schematically showing the processing operations performed by the merchant affinity score calculator 220 to calculate affinity scores for receiving entities, e.g. merchants. As shown, the merchant affinity score calculator 220 receives, at S1, data identifying a seed receiving entity. In this example, the data identifying the seed receiving entity is entered by an operator of the payment service provider network 212. In other examples, the data identifying the seed receiving entity could be retrieved from an external service provider.

The merchant affinity score calculator 220 then sends, at S3, a query to the transaction database 218 to identify a set of sending entities based on each sending entity in the set of sending entities having been the sending entity in at least one transaction with the seed receiving entity. In an example, the merchant affinity score calculator 220 sends a query to the transaction database 218 requesting transaction data from all records in which the seed receiving entity is the receiving entity, receives the requested transaction records, and processes the received transaction records to identify the set of sending entities.

The merchant affinity score calculator 220 then sends, at S5, a query to the transaction database 218 to identify transactions having a sending party in the set of sending parties. The merchant score affinity calculator 220 then determines, at S7, a set of receiving entities based on the transactions having the sending entity in the set of sending entities. In an example, the merchant affinity score calculator 220 sends a query to the transaction database 218 requesting transaction data from all records in which one of the set of sending entities is the sending entity, receives the requested transaction records, and processes the received transaction records to identify the set of receiving entities.

The merchant affinity score calculator 220 then assigns, at S9, the set of sending entities and the set of receiving entities as nodes in a network and transactions as links in the network, a link corresponding to a transaction connecting the sending entity for the transaction to the receiving entity for the transaction. The merchant affinity score calculator 220 then calculates, at S11, an eigenvector centrality value for a node corresponding to a subject receiving entity of the set of receiving entities. The merchant affinity score calculator 220 then determines, at S13, an affinity score for the subject receiving entity using the eigenvector centrality value, and stores the determined affinity score in the merchant affinity score table 222 in association with the identifier of the subject receiving entity.

Although in this example the merchant affinity score calculator 220 in the payment service provider network 212 determines the affinity score for a merchant using the calculated eigenvector centrality score for that merchant, alternatively an eigenvector centrality score for a merchant calculated in the payment service provider network 212 may be made available to an external party for use in the calculation of an affinity score for the merchant. In other examples, the processing operations of FIG. 5 are performed externally to the payment service provider network 212, using either transaction data from the transaction database 218 or from an alternative transaction database.

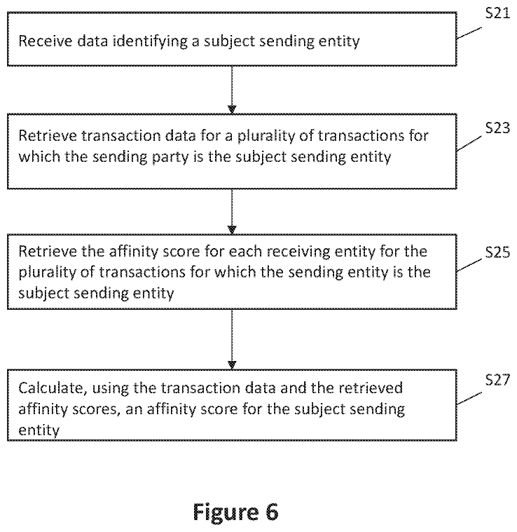

FIG. 6 is a flow chart schematically showing the processing operations performed by a consumer affinity score calculator, which may for example be within a computer system of an issuing bank or a third party service provider, to determine an affinity score for a subject sending entity, e.g. a consumer. As shown, the consumer affinity score calculator receives, at S21, data identifying the subject sending entity. The consumer affinity score calculator then retrieves, at S23, transaction data for a plurality of transaction for which the sending party is the subject sending party. In an example, this transaction data is retrieved from transaction records stored by the issuing bank at which the subject sending party holds an account.

The consumer affinity score calculator then retrieves, at S25, the affinity score for each receiving entity, e.g. merchant, for the plurality of transactions for which the sending entity is the subject sending entity. The consumer affinity calculator then calculates, at S27, an affinity score for the subject sending entity using the retrieved affinity scores for the receiving entities.

It will be appreciated that a consumer may either be a natural person or a legal person, such as a corporation.

While the example of an environmental charity has been given for the seed receiving entity 102 in the above disclosure, the seed receiving entity need not be an environmental charity. For example, the seed receiving entity 102 could be an energy supplier that supplies green energy at a premium price, in which case the set of sending entities 104 may also be expected to share an affinity for environmental sustainability. Further, the seed receiving entity need not have an affinity for environmental sustainability, but can represent a broad range of affinities toward a similar style of fashion brands, or perhaps a set of hobbies with overlapping interests. Another example of a seed receiving entity is a political party in which case the set of sending entities 104 may be expected to share a political affinity.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a computer readable storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The above examples are to be understood as illustrative. It is to be understood that any feature described in relation to any one example may be used alone, or in combination with other features described, and may also be used in combination with one or more features of any other of the examples, or any combination of any other of the examples. Furthermore, equivalents and modifications not described above may also be employed.

What is claimed is:

1. A computer-implemented method for calculating an affinity score for an entity to one or more transactions of a plurality of transactions, each transaction involving the transfer of an asset from an associated sending entity to an associated receiving entity, the method comprising:
receiving data identifying a seed receiving entity;
querying transaction data for the plurality of transactions to identify a set of sending entities based on each sending entity in the set of sending entities having been the sending entity in at least one transaction with the seed receiving entity;
querying the transaction data to identify transactions having a sending entity in the set of sending entities;
determining a set of receiving entities based on the transactions having the sending entity in the set of sending entities;
assigning the set of sending entities and the set of receiving entities as nodes in a network and transactions as links in the network, wherein a link corresponding to a transaction connects the sending entity for the transaction with the receiving entity for the transaction;
calculating an eigenvector centrality value for a node corresponding to a subject receiving entity of the set of receiving entities; and
determining an affinity score for the subject receiving entity using the eigenvector centrality value, whereby the affinity score provides a measure of affinity between the subject receiving entity and the seed receiving entity.

2. The computer-implemented method of claim 1, wherein calculating the eigenvector centrality value for the node comprises applying a PageRank algorithm.

3. The computer-implemented method of claim 1, wherein calculating the eigenvector centrality value for the node comprises weighting each link to the node by a transaction amount of the corresponding transaction.

4. The computer-implemented method of claim 1, further comprising:
receiving data identifying a subject sending entity;
retrieving transaction data for a plurality of transactions for which the sending entity is a subject sending entity;
retrieving the affinity score for each receiving entity for the plurality of transactions for the plurality of transactions for which the sending entity is the subject sending entity; and
calculating, using the transaction data and the retrieved affinity scores, an affinity score for the subject sending entity, whereby the affinity score provides a measure of affinity between the subject sending entity and the seed receiving entity.

5. The computer-implemented method of claim 4, further comprising sending the affinity score for the subject sending entity to the subject sending entity.

6. The computer-implemented method of claim 5, wherein the affinity score for the sending entity is sent to a mobile communication device of the subject sending entity.

7. The computer-implemented method of claim 1, wherein the seed receiving entity is an environmental charity.

8. The computer-implemented method of claim 7, wherein the affinity value corresponds to an estimated carbon dioxide emission amount per unit transaction amount.

9. A server computer comprising:
a processor; and
a computer readable medium storing executable instructions, wherein the processor is configured to execute the stored executable instructions to:
receive data identifying a seed receiving entity;
query a transaction database storing transaction data for a plurality of transactions, each transaction involving the transfer of an asset from an associated sending entity to an associated receiving entity, to identify a set of sending entities based on each sending entity in the set of sending entities having been the sending entity in at least one transaction with the seed receiving entity;
query the transaction database to identify transactions having a sending entity in the set of sending entities;
determine a set of receiving entities based on the transactions having the sending entity in the set of sending entities;
assign the set of sending entities and the set of receiving entities as nodes in a network and transactions as links in the network, wherein a link corresponding to a transaction connects the sending entity for the transaction with the receiving entity for the transaction;
calculate an eigenvector centrality value for a node corresponding to a subject receiving entity of the set of receiving entities; and
determine an affinity score for the subject receiving entity using the eigenvector centrality value, whereby the affinity score provides a measure of affinity between the subject receiving entity and the seed receiving entity.

10. The server computer of claim 9, wherein the stored executable instructions configure the processor to execute a PageRank algorithm to calculate the eigenvector centrality value for the node.

11. The server computer of claim 9, wherein the stored executable instructions configure the processor to weight each link to the node by a transaction amount of the corresponding transaction when calculating the eigenvector centrality value for the node.

12. The server computer of claim 9, wherein the stored executable instructions further configure the processor to:
receive data identifying a subject sending entity;
retrieve transaction data from the transaction database for a plurality of transactions for which the sending entity is a subject sending entity;
retrieve the affinity score for each receiving entity for the plurality of transactions for the plurality of transactions for which the sending entity is the subject sending entity; and
calculate, using the transaction data and the retrieved affinity scores, an affinity score for the subject sending entity, whereby the affinity score provides a measure of affinity between the subject sending entity and the seed receiving entity.

13. The server computer of claim 12, wherein the stored executable instructions further configure the processor to send the affinity score for the subject sending entity to the subject sending entity.

14. The server computer of claim 13, wherein the stored executable instructions further configure the processor to send the affinity score for the sending entity to an application on a mobile communication device of the subject sending entity.

15. The server computer of claim 9, wherein the seed receiving entity is an environmental charity.

16. The server computer of claim 15, wherein the affinity value corresponds to an estimated carbon dioxide emission amount per unit transaction amount.

17. A computer readable medium storing executable instructions, which, when executed by a processor, configure the processor to:
receive data identifying a seed receiving entity;
query a transaction database storing transaction data for a plurality of transactions, each transaction involving the transfer of an asset from an associated sending entity to an associated receiving entity, to identify a set of sending entities based on each sending entity in the set of sending entities having been the sending entity in at least one transaction with the seed receiving entity;
query the transaction database to identify transactions having a sending entity in the set of sending entities;
determine a set of receiving entities based on the transactions having the sending entity in the set of sending entities;
assign the set of sending entities and the set of receiving entities as nodes in a network and transactions as links in the network, wherein a link corresponding to a transaction connects the sending entity for the transaction with the receiving entity for the transaction;
calculate an eigenvector centrality value for a node corresponding to a subject receiving entity of the set of receiving entities; and
determine an affinity score for the subject receiving entity using the eigenvector centrality value, whereby the affinity score provides a measure of affinity between the subject receiving entity and the seed receiving entity.

18. The computer readable medium of claim 17, wherein the stored executable instructions further configure the processor to:
receive data identifying a subject sending entity;
retrieve transaction data from the transaction database for a plurality of transactions for which the sending entity is a subject sending entity;
retrieve the affinity score for each receiving entity for the plurality of transactions for the plurality of transactions for which the sending entity is the subject sending entity; and
calculate, using the transaction data and the retrieved affinity scores, an affinity score for the subject sending entity, whereby the affinity score provides a measure of affinity between the subject sending entity and the seed receiving entity.

19. The computer readable medium of claim 17, wherein the seed receiving entity is an environmental charity.

20. The computer-readable medium of claim 19, wherein the affinity value corresponds to an estimated carbon dioxide emission amount per unit transaction amount.
